(19) United States
(12) Patent Application Publication
(10) Pub. No.: US 2020/0400479 A1
(43) Pub. Date: Dec. 24, 2020

(54) Lighting and Indicator Assembly for Level Gauges

(71) Applicant: Emerson Automation Solutions Final Control US LP, Stafford, TX (US)

(72) Inventors: Ram Kumar Kushwaha, Rohini, (IN); Partha Shinnasamy, Stafford, TX (US)

(21) Appl. No.: 16/898,470

(22) Filed: Jun. 11, 2020

(30) Foreign Application Priority Data
Jun. 22, 2019 (IN) 201911024884

(51) Int. Cl. G01F 23/02; F21V 5/00; F21V 29/83

(52) U.S. Cl. CPC G01F 23/02; F21Y 2115/10; F21V 29/83; F21V 5/007

(57) ABSTRACT

Embodiments of the invention provide a lighting assembly for use with a fluid level indicator assembly. The lighting assembly includes a plurality of lighting elements, at least one printed circuit board configured to control the lighting elements, at least one focusing lens, and a lens assembly. The lighting assembly can be comprised of multiple lighting sub-assemblies, which are stackable to one another to be mounted to level gauges dimensions.

### CROSS-REFERENCE TO RELATED APPLICATIONS

This application claims priority to India Patent Application No. 201911024884, titled “Lighting and Indicator Assembly for Level Gauges” and filed on Jun. 22, 2019, the entirety of which is incorporated herein by reference.

### BACKGROUND

In steam boiler systems, it can be important to maintain a sufficient level of water within the main boiler's steam drum to sustain proper boiler metal operating temperatures. For example, the loss of a significant amount of water from the system can result in failure of the boiler system, such as when water is re-introduced to the steam drum. Numerous technologies exist for measuring the level of liquids or solids in an industrial process environment. Among these are transmitters that measure the water level and transmit a signal representing the actual water level. The techniques for measuring water level include guided wave radar, magnetostrictive, and capacitance. However, in addition to these electronic transmitters that provide remote steam drum level indication and control, typical boiler codes require the presence of one or more level gauges that enable direct, visual evaluation of the steam drum water level. The present disclosure is related to techniques that improve the visibility of a particular type of such level gauges.

### SUMMARY

Some embodiments of the invention provide a lighting assembly to project light through a fluid chamber of a liquid level gauge. The lighting assembly can include at least one light emitting diode (LED) configured to project light through the fluid chamber, at least one printed circuit board (PCB) configured to control the at least one LED, at least one focusing lens disposed between the at least one LED and the fluid chamber to focus the projected light from the LEDs, and a lens assembly. The lens assembly can be configured to direct light of a first color and a second color through the fluid chamber.

Some embodiments of the invention provide an indicator assembly for use to indicate a fluid level of a vessel. The indicator assembly can include a liquid level gauge that includes one or more lighting slots that each traverse a fluid chamber that is configured to be fluidly coupled to the vessel. A lighting assembly can include a plurality of lighting elements that are configured to project light through the fluid chamber, a printed circuit board (PCB) configured to control the lighting elements, and at least one focusing lens that is disposed between the lighting elements and the fluid chamber to focus the projected light from the lighting elements. A lens assembly can be configured to direct light of a first color and a second color through the fluid chamber. The indicator assembly can be arranged such that light of the first color propagates through a viewing slot when a first fluid is present at a first level of the fluid chamber and light of the second color propagates through the viewing slot when a second fluid is present at the first level of the fluid chamber.

Some embodiments of the invention provide indicator assembly for use to indicate a fluid level of a vessel. A liquid level gauge can include a lighting slot and a fluid chamber that is configured to be fluidly coupled to the vessel. A lighting assembly can be configured to project light through the fluid chamber. The lighting assembly can include a plurality of lighting sub-assemblies and a level display. Each of the plurality of lighting sub-assemblies can include a printed circuit board (PCB) configured to control a plurality of lighting elements, at least one focusing lens disposed between the lighting elements and the liquid level gauge, and at least one colored lens. The level display can include a housing with a plurality of viewing windows arranged to correspond with the lighting elements of the lighting sub-assemblies. The plurality of viewing windows can be configured to display a first color of projected light when a first fluid covers the lighting slot and a second color of projected light when a second fluid covers the lighting slot.

### DESCRIPTION OF THE DRAWINGS

FIG. 1 is an exploded side perspective, partially schematic view of a fluid level indicator assembly according to one embodiment of the invention.

FIGS. 2A and 2B show top perspective, partially schematic views of the fluid level indicator assembly indicating steam and water, respectively, using the water level gauge of FIG. 1.

FIG. 3 is a schematic view of lighting sub-assembly of a lighting assembly according to one embodiment of the invention, with lenses removed.

FIG. 4 is a partial view of the lighting sub-assembly of FIG. 3, with lenses shown.

FIG. 5 is a partial view of multiple instances of the lighting sub-assembly of FIG. 3, stacked into a combined lighting sub-assembly.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in that like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Although conventional fluid level indicators are useful in a variety of applications for visualizing the level of fluid, such as for steam/water levels in a steam boiler, conventional illuminating fluid level indicators have a number of drawbacks including lack of mechanical robustness, lack of efficiency in power conversion, high power requirements, overheating during continuous use, lack of customizability, and less than ideal life spans and indicator visibility distances. For example, in conventional illuminating fluid level indicators, the illuminating element, such as an incandescent bulb, does not provide sufficient luminous flux to be seen in certain applications such as in broad daylight, or from a distance that is far away from the level gauge. In these applications, conventional designs have provided dim and unfocused illuminating level indication.

Some fluid level indicators also include a water level gage or a color port gage including a vertical column having bores that pass horizontally through the chamber. The bores are sealed with a glass and cover assembly. Depending on the liquid level of an associated steam boiler system, the vertical chamber can contain one or both of water and steam from the steam boiler system. The glass view ports allow for visual inspection of the contents of the tank present at the corresponding level. With appropriate illumination using a bi-colored light, for example, an operator can be able to inspect and determine the level at which the contents of the column shift from water to steam.

In some cases, the bi-colored light includes an incandescent light source that passes through colored lenses. However, incandescent light sources can suffer from numerous deficiencies, including fragility, inefficiency, substantial power requirements, and relatively short life span. For example, incandescent light sources generally utilize a fragile filament operating at a high temperature. The filament can become damaged and break when subjected to continued vibration from the steam boiler system or other events, thus requiring frequent replacement of the light sources. In addition, the high operating temperature of the filament can also limit the life span of the incandescent light. Further, incandescent light sources can require a high level of power to operate and only a small percentage of this power is converted to usable light. The remaining power is lost, predominantly as heat.

Many fluid level indicators for steam boiler systems are also limited by the size of a corresponding illuminator. For example, the length of the illuminator must generally be suitable for the relevant level indicator of a particular steam boiler system in order to provide accurate fluid level indication. As a result, conventional illumination systems may need to be manufactured to particular and customized lengths, depending on the size of the relevant boiler or level indicator. This can lead to increased manufacturing costs and lead times as well as increased inventory loads.

Embodiments of the invention according to this disclosure can address the issues discussed above, or others, in various ways. For example, to provide lower power consumption than conventional designs, improve luminous intensity, provide customizability and ease of maintenance, and improve light focusing, embodiments of the invention provide improved lighting assemblies for use in corresponding fluid level indicator assemblies. Generally, such a lighting assembly is designed to direct light through a fluid level indicator, which is in fluid communication with a fluid tank, so that a user can easily view the level of fluid in the fluid tank. Some lighting assemblies can include a variety of high intensity lighting elements, arranged on a PCB that controls the lighting elements, so that an optimal (e.g., maximum) light intensity is projected through the fluid level indicator by a focusing lens. In some embodiments, the components of the lighting assembly can be arranged into sub-assemblies to align with the lighting slots of a fluid level indicator. Also, the lighting sub-assemblies can be arranged on one or more rigid (or other) PCBs, so that each lighting assembly can be customizable to a particular size, shape, and design of fluid level indicator. In some embodiments, lighting sub-assemblies can be stackable, to provide customizable lighting for a variety of level gauges using a select number of interchangeable (e.g., substantially identical) modules.

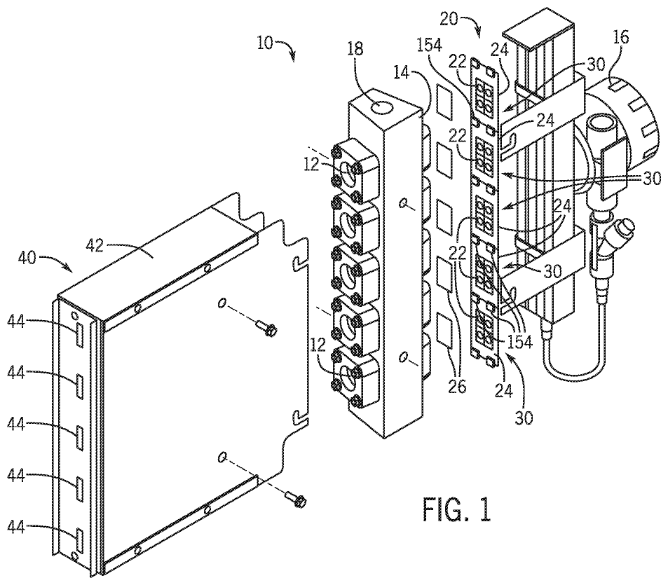

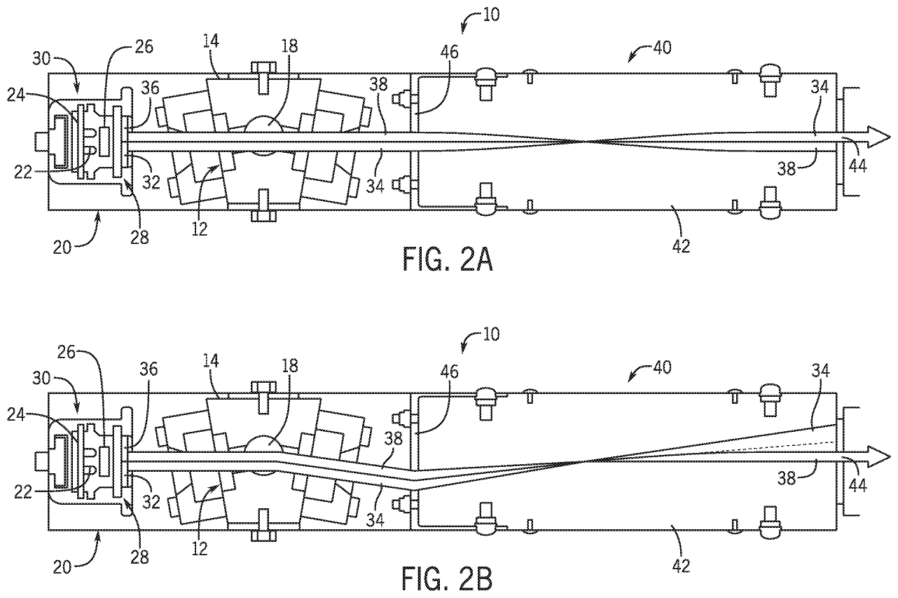

FIGS. 1-2B illustrate a lighting assembly 20 according to an embodiment of the invention, as part of a fluid level indicator assembly 10. Although some embodiments can be particularly useful in combination with indicator assemblies similar to the assembly 10, a variety of other configurations are possible.

In the illustrated embodiment, the lighting assembly 20 includes a plurality of lighting elements 22, a plurality of associated PCBs 24 configured to control the lighting elements 22, one or more focusing lenses 26, and a lens assembly 28 (see FIGS. 2A and 2B). As shown, the lighting elements 22, PCBs 24, and focusing lenses 26 are arranged into lighting sub-assemblies 30, each having one or more of the lighting elements 22, an associated one of the PCBs 24, and one of the focusing lenses 26. In some instances, a lighting sub-assembly can include more than one PCB, and in some instances, the lighting assembly 20 is not arranged into multiple lighting sub-assemblies 30, but rather, can be configured as a unitary (e.g., rather than modular) lighting assembly. In embodiments having multiple lighting sub-assemblies 30, the focusing lens 26 can be formed as a single lens spanning across one or more of the lighting sub-assemblies 30, or the focusing lens 26 can be an array or microarray of lenses formed as a sheet.

In the embodiment illustrated, the lens assembly 28 includes a first pane of glass 32 characterized by a first color 34 (e.g., red) and a second pane of glass 36 characterized by a second color 38 (e.g., green), although other configurations to provide multi-color light output are also possible. While the panes 32, 36 are described as glass, other materials (e.g., poly (methyl methacrylate), etc.) that permit transmission of light of a particular color might be used instead.

As installed for use, the lighting assembly 20 is a part of the indicator assembly 10, which further includes the liquid level gauge 14 having a fluid chamber 18, a power supply 16 (see FIG. 1) for powering the lighting assembly or other components, and a level display 40. The fluid chamber 18 of the liquid level gauge 14 is configured to be attached to, and in fluid communication with, a vessel such as a steam drum of a steam boiler (not shown). Lighting slots 12 extend through the liquid level gauge 14 and are covered, for example, by transparent material to allow the passage of light through one side of the level gauge 14 and out of the other side. The lighting slots 12 each traverse the fluid chamber 18 (see also FIGS. 2A and 2B), so that light can propagate through any one of the lighting slots 12 into, and through, the fluid chamber 18. The liquid level gauge 14 is arranged vertically so that the water level in the fluid chamber 18 of the liquid level gauge 14 corresponds predictably (e.g., directly) to the water level in the vessel.

In the illustrated embodiment, the lighting assembly 20 is positioned on one side of the level gauge 14, and the level display 40 is positioned on the opposite side of the level gauge 14.

The level display 40 includes a housing 42 with a plurality of viewing windows 44 arranged to correspond with the lighting slots 12 and also, in the embodiment illustrated, with the individual sub-assemblies 30 and associated lighting elements 22 of the lighting assembly 20. The level display 40 further includes a convex lens 46, which directs light from the lighting assembly 20 to the viewing windows 44. The lighting assembly 20 can be mechanically coupled to the level display 40 around the level gauge 14 in a variety of ways, including with conventional fasteners or other mechanical devices.

As shown in FIGS. 2A and 2B, when light is projected by the lighting assembly 20 through the lighting slot 12, the projected light is directed through the level display housing 42 and out of viewing windows 44. Thus, a light path extends from the lighting assembly 20 through to the viewing windows 44.

In different embodiments, lighting assemblies can be configured in a variety of ways to project light through a level gauge and an associated housing. For example, as illustrated in particular in FIGS. 2A and 2B, the lighting assembly 20 is generally configured so that the lighting elements 22 project light into the focusing lenses 26, which focus light into the lens assembly 28. The lens assembly 28, in turn, directs light received from the focusing lenses 26 into a lighting slot 12 of a liquid level gauge 14. In this regard, for example, the lighting elements 22 are adjacent to the focusing lens 26, which is adjacent to the lens assembly 28, although other configurations are possible.

In a steam boiler application, for example, due to a difference in the index of refraction of light through water and steam, only one of the two colors emanating from the lens assembly 28 is seen (e.g., green for water and red for steam) through the viewing windows 44, depending on whether water or steam is present in the fluid chamber 18 at the associated level of the level gauge 14 (and, correspondingly, at an equivalent level in the vessel). In this regard, for example, the lens assembly 28 is configured so that focused, projected light of the first color 34 (e.g., red) is directed by the convex lens 46 to the viewing windows 44 when steam is present (FIG. 2A), and focused, projected light of the second color 38 (e.g. green) is directed by the convex lens 46 to the viewing windows 44 when water is present (FIG. 2B). An operator can accordingly inspect the viewing windows 44 to determine the water/steam level in the level gauge 14 by observing the particular color(s) visible through the viewing windows 44 (e.g., noting a change in colors corresponding to a change from water to steam).

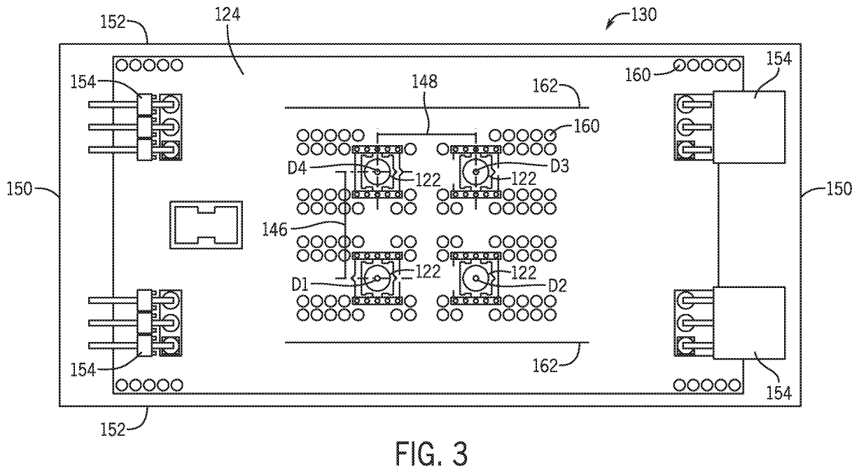

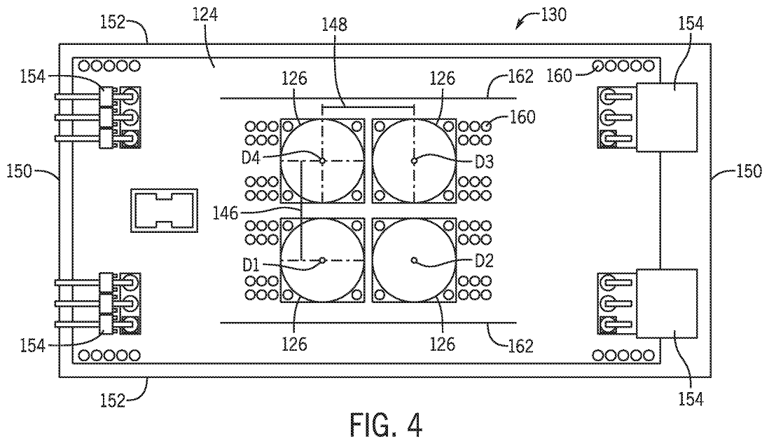

In some embodiments, lighting sub-assemblies can be arranged so that specific components of lighting elements, focusing lens, or other components, or specific spatial arrangements of lighting elements, the focusing lenses 126, or other components can optimize (e.g., maximize intensity of) illumination through associated viewing windows. For example, FIGS. 3-5 illustrate aspects of a lighting sub-assembly 130 according to a particular embodiment of the invention that can provide particular advantages over conventional arrangements. For example, in some arrangements, the illustrated lighting sub-assembly 130, and particularly the illustrated arrangements of lighting elements 122 and focusing lenses 126, can provide unexpectedly bright, and therefore highly viewable, indicators for users.

In different embodiments, different types of arrays of lighting elements can be implemented to provide particularly useful illumination. In the illustrated embodiment, for example, the center points of lighting elements 122 are installed onto position points D1, D2, D3, and D4 in a two by two array. This may be useful, for example, to appropriately concentrate lighting intensity in alignment with an associated viewing window (or other element), although a variety of other configurations are possible.

In different embodiments, the lighting elements 122 can be arranged in arrays with particular dimensional relationships with respect to one another, or with respect to the PCB 124. Referring first to the lighting elements 122 being arranged with respect to one another, in the illustrated embodiment, the center point of each of the four lighting elements 122 align with position points D1-D4 respectively. Further, for example, the distance from the point D1 to the point D4 and from the point D2 to the point D3, e.g. the vertical distance 146, can be between about 9 mm and about 15 mm. In some embodiments, the vertical distance 146 is preferred to be about 11.7 mm, for optimal lighting. Similarly, the distance from D4 to D3 and D1 to D2, e.g. the lateral distance 148, can also be between about 9 mm and about 15 mm. In some embodiments, the lateral distance 148 is preferred to be about 11.3 mm, for optimal lighting.

Referring also to the lighting elements 122 being arranged with respect to the PCB 124, the spacing of lighting elements 122 can also be defined relative to the edges of PCB 124. For example, in the illustrated embodiment, the lateral centerlines of the lighting elements 122 align with the points D1-D4, and the distances from the points D1-D4 to the closest respective lateral edges 150 can be between about 25 mm and about 35 mm, with about 30.7 mm as a preferred distance in some embodiments. Similarly, the vertical centerlines of the lighting elements 122 align with points D1-D4, and the distances from the points D1-D4 to the closest respective vertical edges 152 can be between about 10 mm and about 16 mm, with about 13.2 mm as a preferred distance. In other embodiments, however, other configurations are possible. For example, other two-by-two arrays can have other spacing, can be aligned in diamond or other patterns (e.g., in contrast to the rectangular pattern illustrated in FIG. 3), and so on.

In some embodiments, appropriately configured focusing lenses can provide further intensity to light emission through associated viewing windows. As shown in FIGS. 3-5, for example, the lighting sub-assemblies 130 include four focusing lenses 126, with the center of each focusing lens 126 corresponding to each of the points D1-D4 respectively in a two by two array, in alignment with the lighting elements 122. In some embodiments, the illustrated spatial arrangement of the focusing lens 126, as corresponds to the spatial arrangement of the lighting elements 122, can provide an unexpectedly large intensity of the liquid level indicating colors, e.g. red and green, as seen through viewing windows of a level display. In this way, for example, the level of fluid in a vessel can be determined in daylight conditions from a distance greater than 90 feet away from a level display.

Although some discussion above relates in particular to the lighting sub-assemblies 130, similar considerations can also apply, in some embodiments, to configurations similar to those illustrated in FIGS. 1-2B and other configurations. For example, advantages relating to particular arrangements of the lighting elements 122 and the associated focusing lenses 126, as discussed above, can similarly apply to similar arrangements of the lighting elements 22 and the focusing lenses 26, or various others.

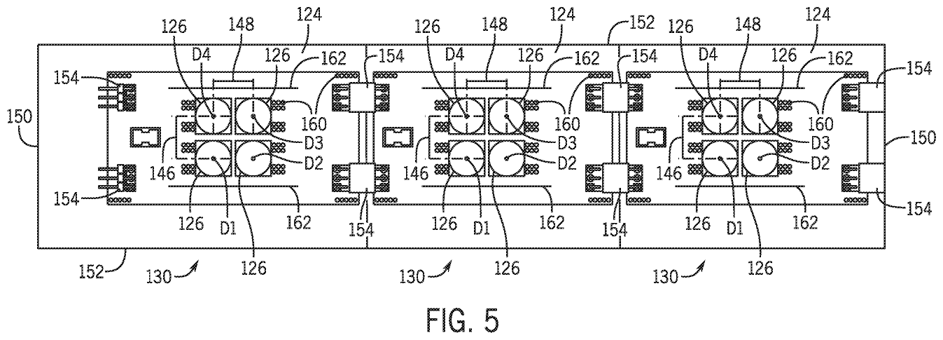

Referring to FIG. 5 in particular, (and also generally illustrated in the embodiment of FIG. 1), multiple instances of the lighting sub-assemblies 130 can be arranged and inter-connected (i.e., stacked) to correspond with a variety of lengths, heights, or other dimensions of an associated liquid level gauge. In this regard, for example, the PCB 124 can be a rigid board, and can include connectors 154 that flexibly or otherwise provide selective coupling of an array of the lighting sub-assemblies 130. In this way, for example, the lighting sub-assemblies 130 can be produced and installed as modular components that can be customizably stacked to conform to the geometry and lighting needs of a particular liquid level gauge. For example, a select set of the lighting sub-assemblies 130 can be customizably stacked together to appropriately optically align with any number and configuration of lighting slots in a liquid level gauge (e.g., each of the slots 12 in the gauge 14).

In some embodiments, multiple stackable lighting sub-assemblies can differ from each other in various ways. In some embodiments, multiple stackable lighting sub-assemblies can be substantially identical to each other, such that manufacturing, inventory management, and installation can be substantially streamlined. Also in this regard, for example, the modularity and stackability of the lighting sub-assemblies can provide for easy repair and replacement of individual lighting sub-assemblies for a particular gauge, when necessary.

In some embodiments, multiple stackable lighting sub-assemblies can be configured differently from the arrangement illustrated in FIG. 5. For example, in some embodiments, different sides of the lighting sub-assemblies 130 than are shown can be arranged adjacent to one another, edges of adjacent lighting sub-assemblies 130 can overlap or be spaced apart from each other, or non-linear arrays of the lighting sub-assemblies 130 can be used. Similarly, for example, a variety of connectors between lighting sub-assemblies can be used, including rigid connectors, flexible connectors, insulating or conductive connectors, and so on.

In some embodiments, particular types of lighting elements can be particularly useful. For example, in contrast to conventional assemblies that may employ through-hole LEDs, each of the lighting elements 22, 122 is a surface-mounted device white LED, or in some instances, a grouping of multiple surface-mounted white LEDs (e.g., as optically aligned with a single associated one of the lenses 26, 126). This arrangement may, for example, usefully provide substantially improved luminous intensity and output power over conventional designs. In other embodiments, however, other configurations are possible. For example, in some embodiments, lighting elements of a lighting sub-assembly can be configured as laser diodes.

As used herein, the term “LED” can refer to an individual (e.g., spatially discrete) light source that uses light-emitting diode technology (e.g., a bulb with an associated LED circuit or circuit assembly), to an individual LED circuit, or to any combination thereof. In some instances, for example, some LEDs can comprise one or more individual LED circuits, which may be configured individually (or collectively) to produce one or more particular forms of light, and which may or may not be associated with (e.g., installed integrally with) a bulb with a built-in lens. In this regard, for example, some configurations of the lighting elements 122 of the PCB 124 (see FIG. 3) can include four spatially separated LEDs, each including a single respective bulb (or other lens) that covers a respective set of one or more LED circuits, or can include four distinct (e.g., spatially separated or individually operable) LED circuits or circuit assemblies, with or without individual or shared bulbs or other optical devices.

In some embodiments, other features can also contribute to improved performance over conventional designs. For example, in the embodiment illustrated, the lighting sub-assembly 130 includes one or more metallic openings 160 in the PCB 124 to provide cooling to the lighting sub-assembly 130 during use. In the embodiment illustrated, the metallic openings 160 are positioned behind the lighting elements 122, and along parts of the perimeter of the PCB 124, although other configurations are also possible.

As another example, multiple mounting slots 162 are also included on the PCB 124. In some embodiments, the mounting slots 162 can be used to secure additional optical (or other) components to the PCB 124, thus further improving the customizability and modularity of the lighting sub-assembly 130. For example, in some embodiments, the mounting slots 162 can be configured to secure a light diffuser to the PCB 124, as may help to provide better light distribution.

Thus, the illustrated embodiments provide an improved lighting assembly for an illuminated fluid indicator assembly. The particular lighting element and focusing lens spacing and components described herein provide increased illumination to fluid level gauge reading, improved cooling of the internal circuitry of the lighting assembly, low power consumption, and customizability among other benefits.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

1. A lighting assembly to project light through a fluid chamber of a liquid level gauge, the lighting assembly comprising:
at least one light emitting diode (LED) configured to project light through the fluid chamber;
at least one printed circuit board (PCB) configured to control the at least one LED;
at least one focusing lens disposed between the at least one LED and the fluid chamber to focus the projected light from the at least one LED; and
a lens assembly configured to direct light of a first color and a second color through the fluid chamber.

2. The lighting assembly of claim 1, wherein the lighting assembly comprises a plurality of lighting sub-assemblies, each of the lighting sub-assemblies including:
one or more LEDs configured to project the light through the fluid chamber;
one or more printed circuit boards (PCBs) configured to control the one or more LEDs; and
one or more focusing lenses disposed between the one or more LEDs and the fluid chamber to focus the projected light from the one or more LEDs.

3. The lighting assembly of claim 2, wherein the lighting sub-assemblies are substantially identical to each other.

4. The lighting assembly of claim 1, wherein a footprint of the at least one LED and the at least one focusing lens extends only within a perimeter of the at least one PCB.

5. The lighting assembly of claim 1, further comprising at least four focusing lenses, each of which is optically aligned with one or more of the at least one LED.

6. The lighting assembly of claim 5, wherein four of the at least four focusing lenses are arranged in a two-by-two array.

7. The lighting assembly of claim 6, wherein the one or more of the at least one LED that are aligned with one of the at least four focusing lenses comprises four LEDs that are arranged in a two-by-two array.

8. The lighting assembly of claim 7, wherein the array of the four LEDs includes at least two sub-arrays separated by a lateral spacing of between 9 and 15 mm.

9. The lighting assembly of claim 8, wherein the array of the four LEDs includes at least two sub-arrays separated by a vertical spacing of between 9 and 15 mm.

10. The lighting assembly of claim 1, wherein a lateral centerline of an array of the at least one LED is disposed between 25 and 35 mm from a lateral edge of the at least one PCB.

11. The lighting assembly of claim 1, wherein a vertical centerline of an array of the at least one LED is disposed between 10 and 16 mm from a vertical edge of the at least one PCB.

12. The lighting assembly of claim 1, wherein the at least one PCB includes a plurality of metallic openings configured to cool the at least one PCB.

13. The lighting assembly of claim 12, wherein the plurality of metallic openings are disposed behind the at least one of LED and along a perimeter of the PCB.

14. The lighting assembly of claim 1, with the liquid level gauge including a plurality of lighting slots arrayed along the fluid chamber,
wherein the at least one PCB includes a plurality of PCBs that are coupled together in an arrangement corresponding to the plurality of lighting slots.

15. The lighting assembly of claim 1, wherein the PCB includes at least one diffuser slot extending between the at least one LED and a vertical edge of the PCB.

16. An indicator assembly for use to indicate a fluid level of a vessel, the indicator assembly comprising:
a liquid level gauge that includes one or more lighting slots that each traverse a fluid chamber that is configured to be fluidly coupled to the vessel; and
a lighting assembly that includes:
a plurality of lighting elements that are configured to project light through the fluid chamber;
a printed circuit board (PCB) that is configured to control the lighting elements;
at least one focusing lens that is disposed between the lighting elements and the fluid chamber to focus the projected light from the lighting elements; and
a lens assembly that is configured to direct light of a first color and a second color through the fluid chamber,
wherein the indicator assembly is arranged such that light of the first color propagates through a viewing slot when a first fluid is present at a first level of the fluid chamber and light of the second color propagates through the viewing slot when a second fluid is present at the first level of the fluid chamber.

17. The indicator assembly of claim 16, wherein each of the plurality of lighting elements includes at least one of a surface-mounted light emitting diode (LED) or a laser diode (LD).

18. The lighting assembly of claim 16, wherein the first fluid includes liquid water and the second fluid includes steam.

19. An indicator assembly for use to indicate a fluid level of a vessel, the indicator assembly comprising:
a liquid level gauge that includes a lighting slot and a fluid chamber that is configured to be fluidly coupled to the vessel; and
a lighting assembly configured to project light through the fluid chamber, the lighting assembly including:
a plurality of lighting sub-assemblies, each including a printed circuit board (PCB) configured to control a plurality of lighting elements, at least one focusing lens disposed between the lighting elements and the liquid level gauge, and at least one colored lens; and
a level display that includes a housing with a plurality of viewing windows arranged to correspond with the lighting elements of the lighting sub-assemblies, the plurality of viewing windows configured to display a first color of projected light when a first fluid covers the lighting slot and a second color of projected light when a second fluid covers the lighting slot.

20. The indicator assembly of claim 19, wherein the plurality of lighting elements includes surface-mounted device light-emitting diodes (SMD LEDs) that emit white light.
